(19) United States
(12) Patent Application Publication
(10) Pub. No.: US 2004/0242808 A1
(43) Pub. Date: Dec. 2, 2004

(54) Method for preparaing polyolefins

(76) Inventors: Robert I Mink, Tarrytown, NY (US); Thomas E. Nowlin, West Windsor, NJ (US); Kenneth G. Schurzky, Bridgewater, NJ (US); Keith dackson, East Aurora, NY (US); Sandra D Schregenberger, Hillsborough, NJ (US); Pradeep P Shirodkar, Kingwood, TX (US)

Correspondence Address: ExxonMobil Chemical Company, Law Technology, PO Box 2149, Baytown, TX, 77522-2149, US

(21) Appl. No.: 10/489,287

(22) PCT Filed: Jul. 9, 2002
(86) PCT No.: PCT/US02/21513

Related U.S. Application Data
(60) Provisional application No. 60/318,805, filed on Sep. 11, 2001.

(51) Int. Cl. C08F 2/00

(52) U.S. Cl. 526/59; 526/60; 526/61

(57) ABSTRACT

A method is disclosed for preparing broad or bimodal molecular weight distribution polyolefins having a targeted property, such as, flow index, melt flow ratio, or weight fractions of higher or lower molecular weight components. The method uses a bimetallic catalyst containing a metallocene component and a non-metallocene component, and the activities of the metallocene and non-metallocene portions are controlled by adjusting the ratio of organoaluminum and modified methylaluminoxane cocatalyst. The method allows for monitoring and adjustment of polyolefin properties on a real-time basis, as the polyolefin is forming.

### FIELD OF THE INVENTION

This invention relates to methods of polyolefin production. More specifically, the invention relates to methods of producing polyolefins having broad or bimodal molecular weight distributions, and methods of controlling the relative amounts of higher and lower molecular weight polymer components of such polyolefins.

### BACKGROUND

Polyethylene homopolymers and higher polymers (copolymers, terpolymers, etc.) with a broad molecular weight distribution (“MWD”) can be used in applications where polymers are needed that are both strong and have low melt viscosity. The high molecular weight fraction in the broad MWD polymer contributes to strength, and the low molecular weight fraction contributes to low melt viscosity.

One measure of the molecular weight distribution of a polymer is melt flow ratio (“MFR”), which is the ratio of flow index (I_{21.6}) to melt index (I_{2.16}) for a given polymer. The MFR value is believed to be an indication of the molecular weight distribution of the polymer: the higher the MFR value, the broader the molecular weight distribution. Polymers having relatively low MFR values, e.g., less than about 50, have relatively narrow molecular weight distributions. Relatively higher MFR values, e.g., above about 50, are generally indicative of relatively broad molecular weight distributions.

MWD and MFR can be used to characterize polymers, e.g., polyolefins, such as linear low density polyethylene (“LLDPE”) and high density polyethylene (“HDPE”) which are often used in films, blow molding, and other applications to make, e.g., bottles or wrapping material. In general, it is desired to have LLDPE and HDPE with broad MWD for good processability, e.g., during film forming processes. In addition, HDPEs (e.g., densities between about 0.940-0.965 g/cm³) with broad MWD have good processability in blow molding applications.

In blow molding and film applications, such polyethylenes can be used, for example, to manufacture bottles, plastic bags and pipes.

Several methods are known for the production of broad MWD polyethylene. Some methods use catalysts, typically chromium-based, that inherently produce polyolefins having a broad MWD. As these catalysts produce polyolefins with broad MWD, polyethylene production can take place in a single reactor.

Another method for production of broad MWD polyethylene uses tandem reactors: two or more reactors connected in sequence. Tandem reactors are generally operated using catalysts that produce polyolefins with narrow MWD, such as catalysts based on titanium or vanadium. The reactors in a tandem system are typically operated under different reaction conditions, e.g., with different amounts of chain transfer agent, resulting in a polyolefin with a broad MWD that may be multi-modal, e.g., bimodal. Using multiple reactors, however, increases the production cost of the polymer. Further, the various weight fractions produced might not be adequately intermixed in the final product, which can lead to a product with inferior melt and/or processing characteristics, such as gels in the product.

Another method for the production of broad MWD polyethylene uses bi-metallic catalysts. Such methods are exemplified by U.S. Pat. No. 6,001,766, the disclosure of which is incorporated by reference herein in its entirety. Catalysts of the '766 patent comprise two transition metal compounds: a cyclopentadienyl complex of a transition metal, and a non-metallocene derivative of a transition metal. In the '766 patent, catalyst precursors are activated with a cocatalyst comprising a combination of an organoaluminum compound such as trialkylaluminum, and modified methylaluminoxane (MMAO). Although the patent discloses that different components of a bimetallic catalyst have different hydrogen responses, hence leading to broad MWD, the patent does not disclose or suggest a method for controlling MWD during polymer production.

Whatever method is used to produce broad MWD polyethylene, it is desired that the polymer produced meet target specifications. Thus, among other specifications, it can be important that the polyethylene have an MWD within a target range. MWD, however, can be difficult to predict and/or control for a variety of reasons.

Several methods are known for controlling the weight fractions of the higher and lower molecular weight polymer components, which in turn affects the MWD of polyethylene, during polyethylene production. When a bimetallic catalyst is used to prepare broad MWD polyethylene in a single reactor, for example, a metal-loading method may be used. In metal-loading methods, weight fractions are regulated through careful control over the ratio of metal components in the catalyst. A difficulty with metal-loading methods is that no two batches of catalyst are ever identical, and polymerization processes include a host of operational parameters other than catalyst metal ratios. Also, impurities in the feeds entering the reactor during the polymerization reaction may affect the efficiencies of the two metals differently. Thus, even if perfect control over the ratio of metals were possible, this would not assure adequate control over the weight fractions of the polymer.

U.S. Pat. No. 5,525,678, the disclosure of which is incorporated by reference in its entirety, discloses another method for controlling weight fractions of a broad MWD polyethylene, comprising feeding water and/or carbon dioxide to a polymerization reactor at levels necessary to modify the weight fractions of the high molecular weight (HMW) and low molecular weight (LMW) polymer components. The method is preferably for use with a bimetallic catalyst in a single polymerization reactor. Other background references include WO 99/33563, U.S. Pat. No. 5,739,226, and M. L. Britto et al., “Copolymerization of Ethylene and 1-Hexene with Et(Ind)₂ZrCl₂ in Hexane”, POLYMER 42 6355-6361 (2001).

There remains a need for methods to control the MFR, weight fractions of the HMW and LMW components, and other product parameters in a polyolefin. Such methods would preferably permit easy control, thereby facilitating production of polyolefins meeting target specifications.

### SUMMARY

It has been surprisingly found that through the combined use of a cocatalyst including a mixture of an organoaluminum component and another cocatalyst component, with a bimetallic catalyst precursor including a metallocene component and a non-metallocene component, the relative catalyst efficiency of the metallocene and non-metallocene components can be regulated. This is a surprising result because organoaluminum cocatalysts, for example, trialkylaluminum cocatalysts such as trimethylaluminum, are not known for activating metallocene catalyst precursors (e.g., zirconium metallocene catalyst precursors) to any significant extent.

The present invention is directed toward a process for producing polyolefins having a target weight fraction of HMW and LMW polymer components. The present invention is also directed toward a process for modifying polymerization conditions to adjust weight fractions of the HMW and LMW polymer components of the polyolefin being produced.

In one aspect, the present invention provides a process for producing polyolefins, the process including: (a) combining catalyst precursor and cocatalyst, the catalyst precursor including a bimetallic catalyst precursor including a non-metallocene compound of a transition metal and a metallocene compound, and the cocatalyst including organoaluminum and modified methylaluminoxane components, to obtain an activated catalyst; (b) preparing a polyolefin by contacting the activated catalyst with an olefin under polymerization conditions; (c) determining at least one product parameter of the polyolefin produced; and (d) varying the ratio of organoaluminum to modified methylaluminoxane components based on the value of the at least one product parameter determined in (c).

In another aspect, the present invention provides polyolefins produced by the process described above.

While any useful product parameter can be used, in some embodiments, product parameters include at least one of a melt flow rate of the polyolefin (such as flow index I_{21.6}, described in more detail below); a weight fraction, e.g., high molecular weight polymer fraction, of the polyolefin; and a melt flow ratio (MFR, such as I_{21.6}/I_{2.16}) of the polyolefin. The melt flow rate of the polyolefin and the weight fraction of the HMW polymer component are related, in that a higher flow index indicates a smaller weight fraction of the HMW polymer component.

When the product parameter includes a melt flow rate, such as a flow index, varying the ratio of organoaluminum component to modified methylaluminoxane component based on the product parameter, in some embodiments, includes comparing the melt flow rate of the polyolefin to a target melt flow rate. When the product parameter includes a weight fraction of the higher molecular weight polymer fraction or the lower molecular weight polymer fraction, varying the ratio of organoaluminum component to modified methylaluminoxane component based on the product parameter, in some embodiments, includes comparing the weight fraction to a target weight fraction. When the product parameter includes a melt flow ratio (MFR), varying the ratio of organoaluminum to modified methylaluminoxane components based on the product parameter, in some embodiments, includes comparing the melt flow ratio of the polyolefin to a target melt flow ratio.

When the product parameter includes a melt flow rate, such as flow index I_{21.6}, varying the ratio of organoaluminum to modified methylaluminoxane components based on the product parameter, in some embodiments, includes at least one of: (i) increasing the ratio of organoaluminum component to modified methylaluminoxane component if the melt flow rate of the polyolefin is less than a target maximum melt flow rate; and (ii) decreasing the ratio of organoaluminum component to modified methylaluminoxane component if the melt flow rate of the polyolefin is greater than a target minimum melt flow rate. Increasing the ratio of organoaluminum component to modified methylaluminoxane component decreases the fraction of the HMW component, and decreasing the ratio of organoaluminum component to modified methylaluminoxane component increases the fraction of the HMW component.

The steps of preparing, determining, and varying are each done at least one time, or alternatively at least two times.

Suitable organoaluminum compounds include trialkylaluminums, such as trimethylaluminum, triethylaluminum, tripropylaluminum, tributylaluminum, triisobutylaluminum, trihexylaluminum and trioctylaluminum, as well as mixtures thereof.

The modified methylaluminoxane (MMAO) in some embodiments includes at least one modified methylaluminoxane that is soluble in an alkane of 4 to 10 carbon atoms. MMAO, such as commercially available MMAO, is believed to have several structural forms, and is typically provided as a mixture of several related compounds. Without wishing to be bound by theory, it is believed that two forms of MMAO can be represented by the formulae:

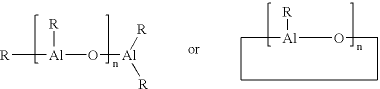

where the formula on the left represents a linear MMAO, and the formula on the right represents a cyclic MMAO; n is 3 to 100; and the R groups preferably include at least 3 mol % of alkyl, alkenyl, or alkynyl groups other than methyl.

In some embodiments, the molar ratio of organoaluminum to modified methylaluminoxane in part (a) above (see paragraph 0016) is in the range of 0.1 to 50.

The bimetallic catalyst precursor comprises a non-metallocene component including at least one of titanium, zirconium, hafnium, vanadium, niobium and tantalum.

In some embodiments, the bimetallic catalyst precursor includes a metallocene component including at least one metallocene compound of titanium, zirconium, or hafnium. Examples of specific compounds include bis(cyclopenta-dienyl)zirconium dichloride, bis(n-butylcyclopentadienyl)zirconium dichloride, bis(1,3-dimethylcyclopentadienyl)zirconium dichloride, bis(pentamethylcyclo-pentadienyl)zirconium dichloride, bis(indenyl)zirconium dichloride, bis(4,5,6,7-tetrahydro-1-indenyl)zirconium dichloride, and cyclopentadienylzirconium tri-chloride.

In some embodiments, the olefin includes at least 80 wt % ethylene-derived units, with the balance being alpha-olefin-derived units, such as C₃-C₁₀ alpha-olefin units.

### BRIEF DESCIPTION OF THE DRAWINGS

FIGS. 1, 2 and 3 are gel permeation chromatography (“GPC”) chromatographs of polymers prepared in Examples 4, 5, and 6, respectively, and illustrate the effect of the molar ratio of organoaluminum:MMAO on polyethylene MWD prepared from a catalyst precursor made according to Example 2.

FIGS. 4 and 5 are GPC chromatographs of polymers prepared in Examples 7 and 8, respectively, and illustrate the effect of the molar ratio of organoaluminum:MMAO on polyethylene MWD prepared from a catalyst precursor made according to Example 3.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description taken with the drawings making apparent to those skilled in the art how the several forms of the invention may be embodied in practice. All percent measurements in this application, unless otherwise stated, are measured by weight based upon 100% of a given sample weight. Thus, for example, 30% represents 30 weight parts out of every 100 weight parts of the sample.

Unless otherwise stated, a reference to a compound or component includes the compound or component by itself, as well as in combination with other compounds or components, such as mixtures of compounds.

Further, when an amount, concentration, or other value or parameter, is given as a list of upper values and lower values, this is to be understood as specifically disclosing all ranges formed from any pair of an upper value and a lower value, regardless whether ranges are separately disclosed.

In one aspect, the present invention is directed toward methods for obtaining polymers, such as polyolefins, exemplified by polyethylenes. In methods of the present invention polymer is produced by contacting olefin monomer, such as ethylene (possibly with other monomers), with catalyst precursor activated by cocatalyst including modified methylaluminoxane (MMAO) compounds and organoaluminum compounds under polymerization conditions. As discussed below, at least one process parameter of the polymer being formed is controlled by regulating the molar ratio of MMAO to organoaluminum components during the polymerization process. It has been surprisingly found that by regulating the molar ratio, based on the aluminum content of each cocatalyst component, of MMAO to organoaluminum components of the cocatalyst, it is possible to regulate the relative proportion of HMW to LMW polymer fractions, and the melt flow properties of the polymer.

In another aspect, the present invention is directed toward catalysts for the production of polyolefins, suitable for use in methods of the present invention. The catalysts include bimetallic catalyst precursors, such as catalyst precursors including metallocene and non-metallocene components, activated with a cocatalyst. In use, the non-metallocene component yields polymer having a relatively higher average molecular weight (HMW), and the metallocene component yields a polymer having a relatively lower average molecular weight (LMW). Catalysts of the present invention, therefore, produce polymer with a broad or bimodal molecular weight distribution attributable to HMW and LMW polymer fractions.

Activation of catalyst precursor is accomplished by contacting the catalyst precursor with a cocatalyst capable of activating both components of the bimetallic catalyst precursor. In some embodiments, the cocatalyst includes both organoaluminum and MMAO components. When the cocatalyst includes both organoaluminum and MMAO components, the cocatalyst components can be added in any order, i.e., simultaneously, first the organoaluminum component, or first the MMAO component. The order and timing of addition does not matter as long as both the organoaluminum and MMAO components are present with the catalyst (or precursor thereof) under polymerization conditions.

When the polymer to be produced is a polyethylene, catalyst precursor is contacted with cocatalyst and ethylene (and optionally one or more α-olefin comonomers) under polymerization conditions to obtain the polymer. Before the polymerization process is complete, however, at least one process parameter of the polymer is measured, such as by testing a sample of the polymer withdrawn from the reaction vessel. Based on the value of the measured process parameter or parameters, the ratio of organoaluminum component to MMAO component is varied, and the polymerization reaction is then permitted to continue. One or more additional iterations of measuring at least one process parameter and varying cocatalyst ratio can be performed if desired.

As noted, polymers prepared using catalyst compositions and methods of the present invention display broad or bimodal molecular weight distributions (MWDs). Any process parameter that indicates a controllable characteristic of the polymer may be used. In some embodiments, the process parameter is an indicator of (though is not necessarily a direct measure of) HMW or LMW fraction of the polymer, or of polymer MWD.

Melt flow ratio (MFR) is an indirect measure of molecular weight distribution. The term “MFR” generally refers to the ratio I_{21.6}/I_{2.16} where I_{21.6} is the “flow index” or melt flow rate of the polymer measured according to ASTM D-1238, condition F, and I_{2.16} is the “melt index” or melt flow rate of the polymer measured according to ASTM D-1238, condition E. The ratio of the two indices, the MFR, can be an indication of the width of the molecular weight distribution, with a larger MFR values often indicating broader MWD.

While the above definition of MFR (I_{21.6}/I_{2.16}) is most common, “MFR” can be used generally to indicate a ratio of melt flow rates measured at a higher load (numerator) to a lower load (denominator). MFR is discussed herein using the particular melt flow rates measured at loads of 21.6 kg (I_{21.6}, the flow index) and 2.16 kg (I_{2.16}, the melt index); however, it should be appreciated, that other ratios of melt flow rates can be used as desired.

Weight average molecular weight, Mw, and number average molecular weight, Mn, can be measured using gel permeation chromatography (GPC), also known as size exclusion chromatography (SEC). This technique utilizes an instrument containing columns packed with porous beads, an elution solvent, and detector in order to separate polymer molecules of different sizes. In a typical measurement, the GPC instrument used is a Waters chromatograph equipped with ultrastyro gel columns operated at 145° C. The elution solvent used is trichlorobenzene. The columns are calibrated using sixteen polystyrene standards of precisely known molecular weights. A correlation of polystyrene retention volume obtained from the standards, to the retention volume of the polymer tested yields the polymer molecular weight. Average molecular weights M can be computed from the expression:

$$M = \frac{{\sum }_{i}^{} {N}_{i} {M}_{i}^{n + 1}}{{\sum }_{i}^{} {N}_{i} {M}_{i}^{n}}$$

where Nᵢ is the number of molecules having a molecular weight Mᵢ. When n=0, M is the number average molecular weight Mn. When n=1, M is the weight average molecular weight Mw. When n=2, M is the Z-average molecular weight Mz. The desired MWD function (e.g., Mw/Mn or Mz/Mw) is the ratio of the corresponding M values. Measurement of M and MWD is well known in the art and is discussed in more detail in, for example, Slade, P. E. Ed., Polymer Molecular Weights Part II, Marcel Dekker, Inc., New York, (1975) 287-368; Rodriguez, F., Principles of Polymer Systems 3rd ed., Hemisphere Pub. Corp., New York, (1989) 155-160; U.S. Pat. No. 4,540,753; Verstrate et al., Macromolecules, vol. 21, (1988) 3360; and references cited therein.

The weight fraction of the relatively higher molecular weight polymer component can be determined by calculating the area under the HMW portion obtained from the gel permeation chromatography (“GPC”) chromatograph relative to the area under the entire GPC chromatograph. (See also, U.S. Pat. No. 5,539,076, and references cited therein.) This weight fraction is based on the sum of the higher and lower molecular weight polymer components, so that:

X_{HMW}=1−X_{LMW}

where X_{HMW} and X_{LMW} are the weight fractions of higher and lower molecular weight polymer components, respectively. It should be understood, therefore, that determining X_{HMW} automatically determines X_{LMW}, and vice versa, and comparing a measured X_{HMW} to a target X_{HMW} is also necessarily comparing 1 minus X_{HMW} (i.e., X_{LMW}) to 1 minus a target X_{HMW}.

Generally, melt flow rates such as the flow index (I_{21.6}) are convenient process parameters, because determination of a melt flow rate is both easy and fast. GPC, while also useful in the present invention, is generally less preferred because of the relatively more time, difficulty, and expense that a GPC measurement takes.

As an illustrative example of the method of the present invention, suppose that for a particular application, a target flow index I_{21.6} is selected. A catalyst precursor (discussed in more detail below) is selected. Under gas phase polymerization conditions, the catalyst precursor is activated and contacted with the monomer or monomers (not necessarily in that order) to begin polymerization. After polymerization is permitted to proceed for about one bed turnover, a polymer sample of about 100 g is withdrawn from the reactor, and the flow index of the polymer is measured. If the measured flow index is higher than the target value, then it is desired to reduce the weight fraction of the LMW polymer component. Accordingly, the ratio of organoaluminum component to MMAO component is decreased, and the reaction allowed to proceed.

On the other hand, if the flow index is lower than the target value, then it is desired to increase the weight fraction of the LMW polymer component. Accordingly, the ratio of organoaluminum component to MMAO component is increased, and the reaction allowed to proceed. The process of allowing polymerization, measuring a product parameter such as flow index, and adjusting the organoaluminum component to MMAO component ratio can be repeated as desired, providing “real-time” control of the polymer parameters.

When MFR is used as a product parameter, the MFR will initially increase (MWD will broaden) with an increase in organoaluminum component to MMAO component molar ratio, but as the ratio is further increased, MFR will typically go through a maximum then begin to decrease. While not wishing to be bound by theory, this is believed to be because the efficiency of the metallocene catalyst component increases, and eventually dominates as compared to the non-metallocene catalyst component. Even after the MFR begins to decrease (after initially increasing), both the weight fraction of the LMW polymer component, and melt flow rates such as the flow index, will continue to increase. Thus, in some embodiments, MFR is used as a product parameter in conjunction with at least one additional product parameter, such as a melt flow rate or high or low molecular weight fraction.

Those skilled in the art will recognize that the ratio of organoaluminum component to MMAO component can be varied by changing the amount of either component or of both components. Another method of adjusting the ratio is simply by adding additional amounts of either cocatalyst component to the reaction vessel. One skilled in the art will recognize that the ratio can be changed by other methods, as well as combinations.

The catalyst precursor can be prepared by combining a non-metallocene component, such as one including Ti, and a metallocene component, such as one including Zr, with optional addition of methylaluminoxane (MAO), optionally followed by drying the catalyst precursor. Suitable catalyst precursors include, but are not limited to, those disclosed in U.S. Pat. No. 6,001,766.

When the non-metallocene component includes titanium, the titanium component may be obtained by any known method, such as the titanium components and methods shown in U.S. Pat. No. 6,001,766. In one embodiment, the Ti component can be obtained by reacting silica sequentially with an alkyl magnesium compound, then an alcohol, and then a titanium compound.

Carrier materials for preparing catalyst precursors according to the present invention include solid, porous carrier materials, and may include carrier materials disclosed in U.S. Pat. No. 4,173,547, the disclosure of which is incorporated by reference herein in its entirety. Such carrier materials include, but are not limited to, metal oxides, hydroxides, halides or other metal salts, such as sulfates, carbonates, phosphates, silicates, and combinations thereof, and may be amorphous or crystalline. Some suitable carrier materials include silica, alumina and combinations thereof. Carrier material particles may have any shape, such as approximately spherical, as, for example, spray dried silica.

Carrier materials can be particles, the optimum size of which can easily be established by one skilled in the art. A carrier material that is too coarse may lead to unfavorable results, such as low bulk density for the polymer powder. In particular embodiments, carrier materials can be particles with average diameter less than 250 μm, or less than 200 μm, or less than 80 μm. The lower limit for carrier material particle size is limited only by practical considerations, such as cost of manufacture. Typical carrier materials can be particles with average diameter greater than 0.1 μm, or greater than 5 μm, or greater than 10 μm.

Carrier material can be porous, as porosity increases the surface area of the carrier material, which, in turn, provides more locations for reaction. The specific surface areas can be measured in accordance with British Standards BS 4359, volume 1 (1969), the disclosure of which is incorporated by reference herein in its entirety. The specific surface area of carrier materials in some embodiments is greater than 3 m²/g, or greater than 50 m²/g, or greater than 150 m²/g, or greater than about 300 m²/g. There is no particular upper limit to carrier material specific surface area, but available products have specific surface area generally less than about 1500 m²/g.

The internal porosity of carrier material can be represented as the ratio of the pore volume to the weight of the material, and can be determined by the BET technique, such as described in Brunauer et al., Journal of the American Chemical Society, 60, 209-319 (1938), the disclosure of which is incorporated by reference herein in its entirety. The internal porosity of carrier material in some embodiments is greater than 0.2 cm³/g, or greater than 0.6 cm³/g, with no preferred upper limit on carrier material internal porosity, which, as a practical matter, is limited by particle size to about 5 cm³/g.

Examples of suitable carrier material include silica, such as amorphous silica, particularly high surface area amorphous silica. Such carrier materials are commercially available from a number of sources, and include Davison 952 or Davison 955 grades of silica (surface area of 300 m²/g and pore volume of 1.65 cm³/g) supplied by the Davison Chemical Division of W.R. Grace and Company, and ES70 silica from Ineos Silicas.

Because organometallic compounds used in obtaining catalysts and catalyst precursors of the present invention may react with water, carrier material used is generally substantially dry. Water that is physically bound to the carrier material can be removed, such as by calcination, prior to forming catalyst precursor of the present invention.

Exemplary calcined carrier material can be carrier material that has been calcined at temperatures higher than 100° C., or higher than 150° C., or higher than 200° C. To avoid sintering of the carrier material, calcination can be done at a temperature less than the sintering temperature of the carrier material. Calcination of a carrier material such as silica, is conveniently done at temperatures of less than 900° C. or less than 850° C.

Any organomagnesium compound can be used when preparing a catalyst precursor for use in the present invention. Some suitable organomagnesium compounds include those shown in U.S. Pat. No. 6,001,766. Organomagnesium compounds used in the present invention preferably include at least one dialkylmagnesium compound, such as compounds of the formula R²ₘMgR³ₙ, where R² and R³ are independently selected aliphatic or aromatic hydrocarbons (e.g., alkyl, alkenyl, alkynyl, aryl groups, or mixtures thereof) which may be straight chain, branched, or cyclic; and where m=2 or 1, and m+n=2. In some embodiments, R² and R³ each have 2 or more carbon atoms, or 4 or more carbon atoms. In some embodiments, R² and R³ each have 12 or fewer carbon atoms, or 8 or fewer carbon atoms. Exemplary dialkylmagnesium compounds include n-butylethylmagnesium, dibutylmagnesium, di-n-hexylmagnesium, and n-butyl-n-octylmagnesium.

It will be understood by those skilled in the art that organomagnesium compounds (as well as other compounds disclosed herein) can be mixtures of more than one chemical formula. For example, dibutylmagnesium, or DBM (available from FMC, Gastonia, N.C.), is understood to include a mixture of n-butyl magnesium, sec-butyl magnesium, and n-octyl magnesium. It is also believed that some organomagnesium compounds from Akzo Nobel (Chicago, Ill.) may contain some aluminum alkyl.

Any alcohol, generally of formula R¹OH, may be used when preparing a catalyst precursor according to the present invention. Preferred alcohols have R¹O— groups which are capable of displacing alkyl groups on the magnesium atom. The inclusion of the alcohol step in the catalyst precursor synthesis produces a catalyst which, relative to the catalyst prepared without this step, is more active, requires less transition metal of the non-metallocene compound, and does not interfere with the performance of the metallocene component in the catalyst.

The R¹ group contains at least one carbon atom, or at least 2 carbon atoms or at least 4 carbon atoms. In some embodiments, the R¹ group can contains up to 12 carbon atoms or up to 8 carbon atoms. Suitable alcohols include, but are not limited to, methanol, ethanol, 1-propanol, isopropanol, 1-butanol, isobutanol, n-octanol, dodecanol, and 4-ethyl decanol.

The non-metallocene component of a transition metal includes at least one compound of a Group 4 or Group 5 transition metal, such as titanium and vanadium. Suitable non-metallocene components include those shown in U.S. Pat. No. 6,001,766.

When a titanium non-metallocene compound is used, the titanium compound can be a compound having empirical formula

Ti(OR⁴)ₓCl_{y}

where each R⁴ is an independently selected C₂-C₁₀ alkyl, alkenyl or alkynyl group, which may be straight-chained, branched, or a combination thereof, y is greater than or equal to 1; and x+y=the valance of the titanium, i.e., 2, 3, or 4. Suitable titanium compounds include those shown in U.S. Pat. No. 6,001,766.

Non-limiting examples of such compounds include titanium halides, such as titanium tetrachloride, titanium alkoxides wherein the alkoxide moiety contains an alkyl radical of 2 to 10 carbon atoms, and mixtures thereof. TiCl₄ can be purchased from a number of suppliers, including, for example, Akzo-Nobel and Aldrich.

By way of illustration, a suitable titanium component may be prepared as follows. Silica, such as Davison grade 955 silica, which has been calcined at about 600° C. for about 4 hours under nitrogen flow, is slurried into an aliphatic hydrocarbon such as isopentane, isohexane, heptane, etc. The silica slurry is then heated to about 50-55° C. with stirring. At about 50-55° C., organomagnesium, such as, dibutylmagnesium (DBM); alcohol, such as 1-butanol, and titanium compound, such as TiCl₄, are sequentially combined with the slurry. After the addition of each reagent, the mixture is stirred for about 1 hour. Finally, the liquid phase is removed under nitrogen flow at about 50° C., to yield a free-flowing powder.

As explained in U.S. Pat. No. 5,336,652, the disclosure of which is incorporated by reference herein in its entirety, the amount of organomagnesium compound can be sufficient to react with the carrier, the added alcohol, and the tetravalent titanium compound, in order to incorporate a catalytically effective amount of titanium in the carrier. The amount of organomagnesium will generally be greater than 0.2 mmol/g, or greater than 0.4 mmol/g, or greater than 0.5 mmol/g, where the amount of organomagnesium compound is given as (mmol Mg/g carrier material). It is preferred not to add more organomagnesium compound than will be physically or chemically deposited into the support, since any excess of the organomagnesium compound in the liquid phase may react with other chemicals used for the catalyst synthesis and precipitate them outside of the support. The amount of organomagnesium compound will generally be less than 3.0 mmol/g, or less than 2.2 mmol/g, or less than 1.5 mmol/g.

If too little alcohol is used, then the catalytic activity attributable to the alcohol will be limited. Thus, the amount of alcohol will generally be greater than 0.5 mmol/mmol organomagnesium, or greater than 0.8 mmol/mmol organomagnesium. Too much alcohol, however, may react with other residual unreacted reagents. Thus, the amount of alcohol will generally be less than 2.0 mmol/mmol organomagnesium, or less than 1.5 mmol/mmol organomagnesium.

The reaction following addition of alcohol is typically carried out at a temperature above 25° C., or above 40° C., and below 80° C., or below 70° C.

Because titanium serves as the active site during polymerization, the amount of titanium compound can be as much as is needed to get a sufficient level of activity. Thus, the amount of titanium compound will generally be greater than 0.1 mmol/g, or greater than 0.2 mmol/g, or greater than 0.3 mmol/g, where the amount of titanium compound is given as (mmol Ti/g carrier material). On the other hand, too much titanium compound may be detrimental, since excess is wasted, and may also react with other residual unreacted reagents. Moreover, high levels of Ti in the polymer may adversely affect polymer properties. Thus, the amount of titanium compound will generally be less than 4.5 mmol/g, or less than 2.5 mmol/g, or less than 1.5 mmol/g.

The metallocene component of a transition metal includes a compound of a Group 4 transition metal, such as metallocene compounds of zirconium, titanium and hafnium, preferably zirconium. Suitable metallocene components include those shown in U.S. Pat. No. 6,001,766.

The metallocene compound may be obtained by any known method. In some embodiments, the metallocene component is obtained by reacting trialkylaluminum with a Group 4 transition metal compound of formula:

(R′₅—Cp)₂MCl₂

where M is a Group 4 transition metal, Cp denotes a cyclopentadienyl group and each R′ is independently hydrogen or C₁-C₁₀ alkyl. The cyclopentadienyl group may be unsubstituted (each R′ is hydrogen) or substituted (at least one R′ is other than hydrogen). Further, the two R′—Cp groups may be independently selected and need not be identical to each other. Mixtures of metallocene compounds may also be used. Trialkylaluminum compounds include compounds of formula R″₃Al, where R″ is a C₁-C₁₀ alkyl, such as methyl, ethyl, isobutyl, n-octyl, etc. Mixtures of trialkylaluminum compounds may also be used.

One skilled in the art can obtain a metallocene component for use according to the present invention in a variety of ways. By way of illustration, a Zr component may be prepared by reacting (R′₅—Cp)₂ZrCl₂ with R″₃Al in a hydrocarbon solvent at ambient temperature.

Before the metallocene component is contacted with the non-metallocene component, in one embodiment, the metallocene component is contacted with an alkylaluminum compound, such as a trialkylaluminum, as shown in U.S. Pat. No. 6,001,766.

The metallocene and non-metallocene components are combined by any method. For example, the reaction product solution of the metallocene component can be combined with a slurry of the non-metallocene component in an aliphatic hydrocarbon at 50-55° C., and the mixture then stirred for about 1 hour.

During preparation of the bimetallic catalyst precursors, MAO, optionally dissolved in a solvent such as toluene, is optionally combined with the metallocene and non-metallocene components, and the mixture stirred for about 1 hour at 50-55° C. Addition of MAO is especially suitable when the metallocene component includes unsubstituted cyclopentadienyl groups (R is hydrogen). The liquid phase may then be removed, such as under nitrogen flow at about 50° C., to yield catalyst precursor, which is preferably a free-flowing powder.

Activation of catalyst precursor may be undertaken prior to introduction into the polymerization reaction vessel, or in the polymerization reaction vessel.

The organoaluminum component can include an organoaluminum compound, as described in U.S. Pat. No. 6,001,766. Particular cocatalysts include organoaluminum compounds having empirical formula

Al(R⁵)ₐ(H)_{b}(X)_{c}

where R⁵ is an organic radical as described below; X is a halide; a is an integer from 1 to 3; and a+b+c=3. The R⁵ groups are independently selected alkyl or alkoxy groups which may be straight chain or branched, saturated or unsaturated. The R⁵ groups preferably contain 30 or fewer carbons, or 10 or fewer carbon atoms. Non-limiting examples of suitable compounds having the above empirical formula include trialkylaluminum compounds, such as trimethylaluminum, triethylaluminum, tripropylaluminum, tributylaluminum, triisobutylaluminum, trihexylaluminum, trioctylaluminum, diisobutylhexylaluminum, and isobutyldihexylaluminum; alkyl aluminum hydrides, such as diisobutylaluminum hydride and dihexylaluminum hydride; alkylalkoxy organoaluminum compounds; and halogencontaining organoaluminum compounds, such as diethylaluminum chloride and diisobutylaluminum chloride.

Triethylaluminum may also be used, but because H₂ is a strong poison for triethylaluminum, use of triethylaluminum is less suitable when H₂ is used as a chain transfer agent.

MMAO (modified methylaluminoxane) components useful in the present invention include the MMAOs disclosed in U.S. Pat. No. 6,001,766, wherein they are generally referred to as “alkylaluminoxanes” or more specifically as “modified methylaluminoxanes.” In some embodiments, the MMAOs are at least partially soluble or colloidally suspendible in aliphatics (alkanes, alkenes, and alkynes) of about 4 to 10 carbon atoms. The modifying groups may include methyl groups, and preferably include alkyl groups having about 2 to 8 carbon atoms. MMAO mixtures may also be used, e.g., mixtures including linear and non-linear (e.g. cyclic) MMAO, and/or mixtures of MMAO that predominate in different oligomers.

MMAO is commercially available at a concentration of 8 wt % Al or less in paraffinic solvents (isopentane, hexane, heptane, etc.). These commercial solutions or suspensions are generally clear, but cloudiness is not expected to affect performance, or lead to difficulty in feeding the MMAO into the reactor. It is not expected that there should be any criticality on the particular MMAO selected.

Any effective amount of the cocatalyst components may be used in methods of the present invention. In general, the molar ratio of organoaluminum component to MMAO component will be in the range of 0.1 to 50, or 0.1 to 30, based on the aluminum content of each cocatalyst component.

Catalysts of the present invention may be used in any type of polymerization or copolymerization process, including, for example, fluidized-bed, slurry, or solution processes, such as for olefin polymerization or copolymerization reactions.

The choice of monomers used in a polymerization according to the present invention can be made by one skilled in the art based on the type of polyolefin to be produced. Polyethylenes, for example, may be produced by polymerizing ethylene, optionally in the presence of one or more higher olefins, such as one or more alpha-olefins. Suitable alpha-olefins include, for example, C₃-C₁₀ alpha-olefins, such as propylene, 1-butene, 1-hexene, 4-methyl-1-pentene, and 1-octene. Mixtures of alpha-olefins may also be used.

Hydrogen can be used as a chain transfer agent in the polymerization reaction with the catalysts and methods of the present invention. Other reaction conditions being the same, a greater amount of hydrogen decreases the average molecular weight of the polymer. The ratio of hydrogen to monomer will vary depending on the desired average molecular weight of polymer, and can be determined by one skilled in the art for each particular application. When the desired polymer is polyethylene or an ethylene copolymer, the amount of hydrogen will generally be from 0 to 2.0 moles of hydrogen per mole of ethylene.

Polymerization temperature and time can be determined by one skilled in the art based on a number of factors, such as the type of polymerization process and the type of polymer to be prepared.

Polymerization temperature should be high enough to obtain an acceptable polymerization rate. In general, polymerization temperatures are greater than 30° C., or greater than 75° C. On the other hand, polymerization temperature should not be so high as to cause degradation of catalyst or polymer. Specifically with respect to a fluidized-bed process, the reaction temperature is not so high as to lead to sintering of polymer particles. In general, polymerization temperatures are less than 300° C., or less than 115° C., or less than 105° C. As is generally known, polymers such as polyolefins may be polymerized at temperatures that are partially determined by the density of the desired product. Thus, for example, polyethylene resins having densities below 0.92 g/cm³ are typically polymerized at temperatures from 60-90° C. Polyethylene resins having densities of 0.92 to 0.94 g/cm³ are polymerized at temperatures from 70-100° C. Polyethylene resins having densities above 0.94 g/cm³ are polymerized at temperatures from 80-115° C. It should be appreciated that these temperatures and densities are approximate and are given for illustrative purposes only.

When a fluidized-bed reactor is used in a method of the present invention, one skilled in the art is readily able to determine appropriate pressures and other reaction conditions. Fluidized-bed reactors are typically operated at pressures of up to about 1000 psi (7 MPa), and are generally operated at pressures below about 350 psi (2 MPa). Typically, a fluidized-bed reactor is operated at a pressure above about 150 psi (1 MPa). As is known in the art, operation at higher pressures favors heat transfer because an increase in pressure increases the unit volume heat capacity of the gas.

Once the catalyst precursor is activated, the activated catalyst has a limited lifetime before it becomes deactivated. As is known to those skilled in the art, the half-life of an activated catalyst depends on a number of factors, such as the species of catalyst precursor and cocatalyst, the presence of impurities (e.g., water or oxygen) in the reaction vessel, and other factors. An appropriate length of time for carrying out a polymerization reaction can be determined by one skilled in the art for each particular situation.

Catalysts and methods of the present invention can be used to prepare various types of polyolefins, such as polyethylenes, including high density polyethylene (HDPE) and linear low density polyethylene (LLDPE). An LLDPE resin typically has a density of less than about 0.94 g/cm³, whereas an HDPE typically has a density of more than about 0.94 g/cm³. An HDPE is prepared from a feedstock with a high proportion of ethylene and only small amounts, typically up to about 1.5 mol %, of higher olefin. As the level of higher olefin in the feedstock increases, more higher olefin is incorporated into the polyolefin, which interferes with formation of dense crystalline regions. Thus, higher olefins may be used to obtain LLDPE, as the higher olefins decrease the density of polyethylenes.

As is known in the art, the higher alpha-olefins tend to be less reactive than ethylene, and so are generally incorporated into a polymer at a lesser mole fraction than their mole fraction in the feedstock. Further, each catalyst incorporates higher olefins at a rate specific to the catalyst. This property of the catalyst composition is referred to as “higher alpha-olefin incorporation property” and is usually measured by determining the amount of a higher alpha-olefin (e.g., 1-butene, 1-hexene or 1-octene) required in the polymerization process, e.g. fluid-bed reactor process, to produce a copolymer of ethylene and the higher alpha-olefin having a given density. It is a matter of ordinary experimentation to determine what levels of higher olefin in the feedstock are required to produce a polyolefin of a desired density from a particular catalyst and higher olefin.

As noted above, higher olefins are optionally included in the monomer feedstock to adjust polymer properties, such as. Thus, polyethylenes produced with catalysts and methods of the present invention include polyethylene homopolymers, as well as polyethylene copolymers, where the term “copolymers” includes terpolymers and higher polymers. Polyethylene homopolymers prepared with catalysts and methods of the present invention are typically HDPEs. Polyethylene co- and higher-polymers may be HDPE or LLDPE, depending on the amount of higher olefin incorporated from the feedstock. Particular examples of polyethylene copolymers include, but are not limited to, ethylene/1-butene copolymers, ethylene/1-hexene copolymers, ethylene/4-methyl-1-pentene copolymers, ethylene/1-butene/1-hexene terpolymers, ethylene/propylene/1-hexene terpolymers and ethylene/propylene/1-butene terpolymers.

Catalysts of the present invention preferably have activities greater than about 1000 grams polyolefin/gram catalyst, so that the deactivated catalyst (which was obtained from the activated catalyst) does not need to be removed before further processing of the polyolefin. Thus, polyolefins prepared according to the present invention generally include deactivated catalyst.

### EXAMPLES

The present invention will be further illustrated by way of the following Examples, which, among other things, describe syntheses of catalyst precursors and catalysts of the present invention, and the use and evaluation of catalyst systems of the present invention in polymerization reactions. These examples are non-limiting and do not restrict the scope of the invention.

Unless stated otherwise, all percentages, parts, etc. presented in the examples are by weight.

### Example 1

Preparation of Titanium Component

Davison grade 955 silica (6.00 g), which had been calcined at 600° C. under nitrogen flow for 4 hours, was placed into a Schlenk flask. Isohexane (˜100 mL) was then added to the flask, and the flask was placed into an oil bath (55° C.). Dibutylmagnesium (DBM) (4.32 mmol) was added to the stirred silica slurry at 55° C., and stirring was continued for 1 hour. Then, 1-butanol (4.10 mmol) was added at 55° C. and the mixture stirred for 1 hour. Finally, TiCl₄ (2.592 mmol) was added at 55° C. to the reaction medium and stirring was continued for 1 hour. The liquid phase was removed by evaporation under nitrogen flow to yield a free-flowing powder.

### Example 2

Preparation of Catalyst Precursor

Powder prepared according to Example 1 (2.00 g) was reslurried in isohexane (˜50 mL) and the slurry was heated to 50° C. A Zr complex was prepared by reacting triisobutylaluminum (0.80 mmol) in heptane (˜1 mL) with Cp₂ZrCl₂ (0.056 mmol, 0.0164 g). The solution of the Zr complex in heptane was added to the slurry.

After stirring the mixture at about 50° C. for about 1 hour, the liquid phase was removed by evaporation under nitrogen flow to yield a free-flowing powder. Weight percent of Ti and Zr were found to be 1.63 and 0.23, respectively.

### Example 3

### Preparation of Catalyst Precursor

Powder prepared according to Example 1 (2.00 g) was reslurried in isohexane (˜50 mL) and the slurry was heated to 50° C. A Zr complex was prepared by reacting triethylaluminum (0.80 mmol) in heptane (˜0.5 mL) with Cp₂ZrCl₂ (0.108 mmol, 0.0316 g) in toluene. The solution of the Zr complex was added to the slurry.

After stirring the mixture at about 50° C. for about 1 hour, MAO in toluene (3.00 mmol) was added to the slurry. After stirring the mixture at about 50° C. for about more 1 hour, the liquid phase was removed by evaporation under nitrogen flow to yield a free-flowing powder. Weight percent of Ti and Zr were found to be 1.53 and 0.42, respectively.

### Examples 4 to 8

Polymerization Reactions

Ethylene/1-hexene copolymers were prepared with the bimetallic catalyst precursors and the cocatalyst mixture of TMA (trimethylaluminum) and MMAO in slurry polymerization reactions. An example is given below.

A 1.6 L stainless steel autoclave equipped with a magnet-drive impeller stirrer was filled with heptane (750 mL) and 1-hexene (30 mL) under a slow nitrogen purge at 50° C., and then TMA and MMAO were added. The reactor vent was closed, the stirring rate increased to 1000 rpm, and the temperature increased to 95° C. The internal pressure was raised 12 psi (83 kPa) with hydrogen and then ethylene was introduced to maintain the total pressure at 204-211 psig (1.41-1.45 MPa). Next, the temperature was decreased to 85° C., 20.0-30.0 mg of the bimetallic catalyst precursor was introduced into the reactor with ethylene over-pressure, and the temperature was increased and held at 95° C. The polymerization reaction was carried out for 1 hour, and then the ethylene supply was stopped. The reactor was cooled to ambient temperature, and the polyethylene collected.

The slurry polymerization results using the catalyst precursor of Examples 2 and 3 are given in Table 1.

TABLE 1

| | Catalyst | Cocatalyst Mixture | Productivity | I_{21.6} | |
|---|---|---|---|---|---|
| Example | Precursor | TMA (mmol Al); MMAO (mmol Al) | (g/g · hr) | (g/10 min) | X_{HMW} |
| 4 | Example 2 | TMA (0); MMAO (2.4) | 5110 | 3.7 | 0.93 |
| 5 | Example 2 | TMA (1.2); MMAO (2.4) | 6030 | 8.2 | 0.69 |
| 6 | Example 2 | TMA (2.4); MMAO (2.4) | 6890 | 18.7 | 0.59 |
| 7 | Example 3 | TMA (0); MMAO (2.0) | 3530 | 3.9 | 0.88 |
| 8 | Example 3 | TMA (2.0); MMAO (2.0) | 7010 | 26.6 | 0.59 |

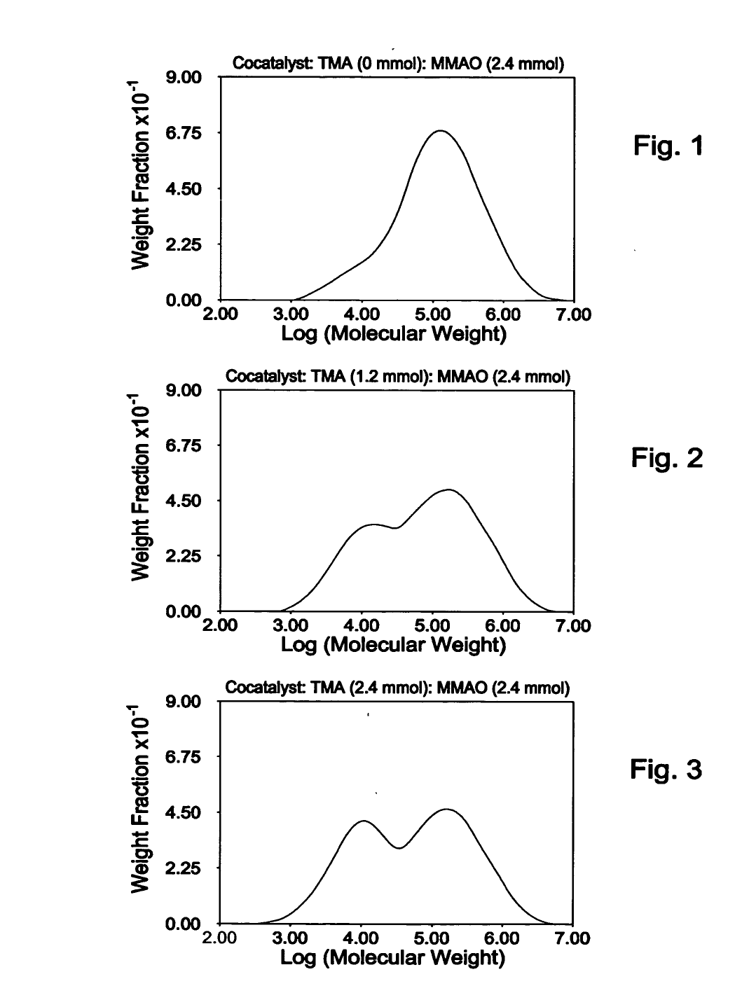

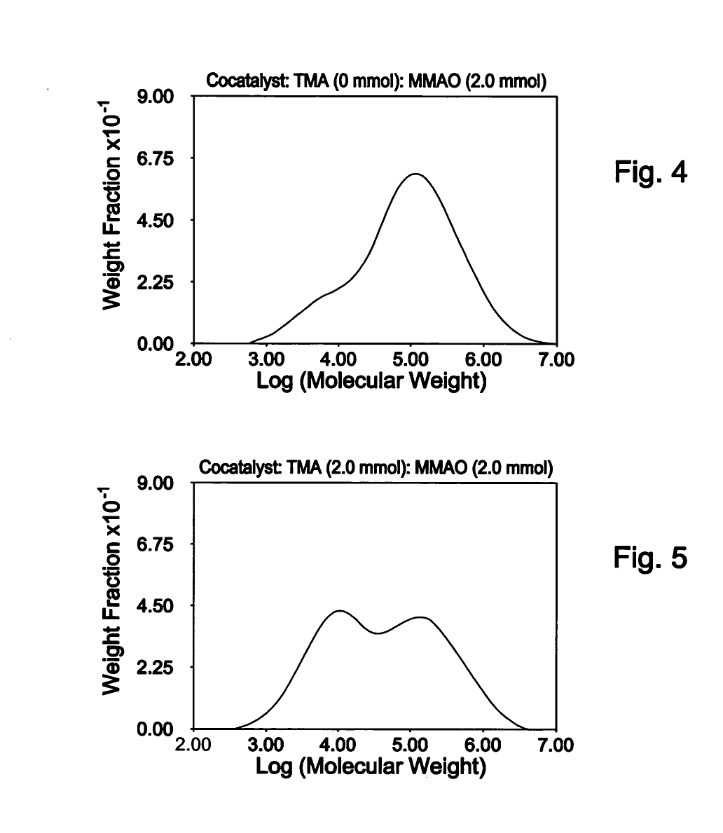

X_{HMW} is the weight fraction of the HMW polymer component estimated based on deconvolution of GPC data. The GPC chromatographs for the polymers of Examples 4 to 8 are shown in FIGS. 1 to 5, respectively.

The slurry data show that increasing the amount of TMA from 0 to 1.2 to 2.4 mmol in the cocatalyst mixture at a given MMAO loading (2.4 or 2.0 results in resins with a higher flow index and lower X_{HMW}, indicative of Zr efficiencies. The calculated Zr and Ti efficiencies for the catalyst systems of Table 1 are shown in Table 2. The efficiency is given in units of kilograms of polyethylene per gram of metal (Zr or Ti).

TABLE 2

| | Catalyst | Cocatalyst Mixture | Zr efficiency | Ti efficiency |
|---|---|---|---|---|
| Example | Precursor | TMA (mmol Al); MMAO (mmol Al) | (kg PE/g Zr) | (kg PE/g Ti) |
| 4 | Example 2 | TMA (O); MMAO (2.4) | 155.5 | 291.6 |
| 5 | Example 2 | TMA (1.2); MMAO (2.4) | 812.7 | 255.3 |
| 6 | Example 2 | TMA (2.4); MMAO (2.4) | 1228.2 | 249.4 |
| 7 | Example 3 | TMA (0); MMAO (2.0) | 100.9 | 203.1 |
| 8 | Example 3 | TMA (2.0); MMAO (2.0) | 684.6 | 270.4 |

The Zr efficiency is very dependent upon the TMA loading in the cocatalyst mixture, whereas the Ti efficiency remains in the 200-300 kg PE/g range whether TMA is present or not. Using MMAO alone as the cocatalyst results in a Zr efficiency of less than 200 kg PE/g Zr, but for a cocatalyst mixture of TMA and MMAO, the Zr efficiency increases by greater than 500%.

### Example 9

Polymerization in Fluidized-Bed

A resin sample was prepared in the fluidized-bed reactor with the catalyst precursor of Example 3. The process conditions and resin characteristics are given in Table 3.

TABLE 3

| Process Conditions | |
|---|---|
| Ethylene partial pressure, psi (kPa) | 154 (1060) |
| Isopentane partial pressure, psi (kPa) | 29.6, (204) |
| 1-hexene/ethylene mole ratio (gas phase) | 0.0076 |
| H₂/ethylene mole ratio (gas phase) | 0.0221 |
| Bed Temperature, ° C. | 85.0 |
| MMAO, ppm | 90 |
| TMA, ppm | 152 |
| Overall Productivity, kg PE/kg catalyst | 7688 |
| Zr efficiency, kg PE/g Zr | 787 |
| Ti efficiency, kg PE/g TI | 286 |
| Resin Characteristics | |
| Flow Index (I_{21.6}) g/10 min | 13.9 |
| MFR (I_{21.6}/I_{2.16}) | 110 |
| Density, g/cm³ | 0.952 |

While the invention has been described in connection with certain preferred embodiments so that aspects thereof may be more fully understood and appreciated, it is not intended to limit the invention to these particular embodiments. On the contrary, it is intended to cover all alternatives, modifications and equivalents as may be included within the scope of the invention as defined by the appended claims.

All patents, test procedures, and other documents cited herein, including priority documents, are fully incorporated by reference to the extent such disclosure is not inconsistent with this invention and for all jurisdictions in which such incorporation is permitted.

What is claimed is:

1. A process for producing polyolefin, the process comprising:
(a) combining a catalyst precursor and a cocatalyst, the catalyst precursor comprising a bimetallic catalyst precursor comprising a non-metallocene compound of a transition metal and a metallocene compound, and the cocatalyst comprising an organoaluminum component and a modified methylaluminoxane component, to obtain an activated catalyst;
(b) contacting the activated catalyst with olefin monomers under polymerization conditions to form polyolefin;
(c) determining at least one product parameter of the polyolefin; and
(d) varying the ratio of organoaluminum component to modified methylaluminoxane component based on comparing the product parameter to a target product parameter.

2. The process of claim 1, wherein the at least one product parameter comprises a melt flow rate, and the target product parameter comprises a target melt flow rate.

3. The process of claim 2, wherein the melt flow rate is the flow index I_{21.6}.

4. The process of claim 2, wherein varying the ratio of organoaluminum component to modified methylaluminoxane component based on the product parameter comprises comparing the melt flow rate to the target melt flow rate.

5. The process of claim 2, wherein varying the ratio of organoaluminum component to modified methylaluminoxane component based on the product parameter comprises at least one of:
(d1) increasing the ratio of organoaluminum component to modified methylaluminoxane component if the melt flow rate is less than the target melt flow rate; and
(d2) decreasing the ratio of organoaluminum component to modified methylaluminoxane component if the melt flow rate is greater than the target melt flow rate.

6. The process of claim 1, wherein the polyolefin comprises a relatively higher molecular weight polymer component and a relatively lower molecular weight polymer component, the at least one product parameter comprises a weight fraction of the higher molecular weight polymer component, and the target product parameter comprises a target weight fraction of the higher molecular weight polymer component.

7. The process of claim 6, wherein varying the ratio of organoaluminum component to modified methylaluminoxane component based on the product parameter comprises increasing the ratio of organoaluminum component to modified methylaluminoxane component if the weight fraction of the higher molecular weight component is greater than the target weight fraction or decreasing the ratio of organoaluminum component to modified methylaluminoxane component if the weight fraction of the higher molecular weight component is less than the target weight fraction.

8. The process of claim 1, wherein the contacting, determining, and varying are each done at least two times.

9. The process of claim 1, wherein the organoaluminum component comprises at least one trialkylaluminum compound.

10. The process of claim 9 wherein the trialkylaluminum compound comprises at least one of trimethylaluminum, triethylaluminum, tripropylaluminum, tributylaluminum, triisobutylaluminum, trihexylaluminum and trioctylaluminum.

11. The process of claim 1, wherein the molar ratio of aluminum in the organoaluminum component to aluminum in the modified methylaluminoxane component is in the range of 0.1 to 50.

12. The process of claim 1, wherein the bimetallic catalyst precursor comprises a non-metallocene component comprising at least one of titanium, zirconium, hafnium, vanadium, niobium and tantalum, and a metallocene component comprising at least one metallocene of at least one of titanium, zirconium, and hafnium.

13. The process of claim 12, wherein the bimetallic catalyst precursor comprises a non-metallocene component comprising at least one of titanium and vanadium, and a metallocene component comprising at least one metallocene of zirconium.

14. The process of claim 1, wherein the olefin monomers comprises at least 80 wt % ethylene.

15. The process of claim 14, wherein the olefin monomers further comprises at least one C₃-C₁₀ alpha-olefin monomer.

16. The process of claim 1, wherein the at least one product parameter further comprises a melt flow ratio, and the target product parameter further comprises a target melt flow ratio.

17. The process of claim 16, wherein the melt flow ratio is I_{21.6}/I_{2.16}.

18. A process for producing polyolefins having a target melt flow rate, the process comprising:
(a) combining a catalyst precursor and a cocatalyst, the catalyst precursor comprising a bimetallic catalyst precursor comprising a non-metallocene compound of a transition metal and a metallocene compound, and the cocatalyst comprising an organoaluminum component and a modified methylaluminoxane component, to obtain an activated catalyst;
(b) contacting the activated catalyst with olefin monomers under polymerization conditions to form polyolefin;
(c) determining a melt flow rate of the polyolefin; and
(d) increasing the ratio of organoaluminum component to modified methylaluminoxane component if the melt flow rate is less than the target melt flow rate or decreasing the ratio of organoaluminum component to modified methylaluminoxane component if the melt flow rate is greater than the target melt flow rate.

19. The process of claim 18, wherein the melt flow rate is the flow index I_{21.6}.

20. The process of claim 18, wherein the contacting, determining, and varying are each done at least two times.

21. The process of claim 18, wherein the organoaluminum component comprises at least one trialkylaluminum compound.

22. The process of claim 21, wherein the trialkylaluminum compound comprises at least one of trimethylaluminum, triethylaluminum, tripropylaluminum, tributylaluminum, triisobutylaluminum, trihexylaluminum and trioctylaluminum.

23. The process of claim 18, wherein the bimetallic catalyst precursor comprises a non-metallocene component comprising at least one of titanium, zirconium, hafnium, vanadium, niobium and tantalum, and a metallocene component comprising at least one metallocene of at least one of titanium, zirconium, and hafnium.

24. The process of claim 23, wherein the bimetallic catalyst precursor comprises a non-metallocene component comprising at least one of titanium and vanadium, and a metallocene component comprising at least one metallocene of zirconium.

25. The process of claim 18, wherein the olefin monomers comprises at least 80 wt % ethylene.

26. The process of claim 18, wherein the olefin monomers further comprises at least one C₃-C₁₀ alpha-olefin monomer.

27. A process for producing polyolefins comprising a relatively higher molecular weight polymer component and a relatively lower molecular weight polymer component and having target weight fractions of higher and lower molecular weight polymer components, the process comprising:
(a) combining a catalyst precursor and a cocatalyst, the catalyst precursor comprising a bimetallic catalyst precursor comprising a non-metallocene compound of a transition metal and a metallocene compound, and the cocatalyst comprising an organoaluminum component and a modified methylaluminoxane component, to obtain an activated catalyst;
(b) contacting the activated catalyst with olefin monomers under polymerization conditions to form polyolefin;
(c) determining the weight fraction of at least one of the higher molecular weight polymer component and the lower molecular weight polymer component; and
(d) varying the ratio of organoaluminum component to modified methylaluminoxane component by increasing the ratio of organoaluminum component to modified methylaluminoxane component if the weight fraction of the higher molecular weight component is greater than a target weight fraction or decreasing the ratio of organoaluminum component to modified methylaluminoxane component if the weight fraction of the higher molecular weight component is less than the target weight fraction.

28. The process of claim 27, wherein the contacting, determining, and varying are each done at least two times.

29. The process of claim 27, wherein the organoaluminum component comprises at least one trialkylaluminum compound.

30. The process of claim 29 wherein the trialkylaluminum compound comprises at least one of trimethylaluminum, triethylaluminum, tripropylaluminum, tributylaluminum, triisobutylaluminum, trihexylaluminum and 1 trioctylaluminum.

31. The process of claim 27, wherein the bimetallic catalyst precursor comprises a non-metallocene component comprising at least one of titanium, zirconium, hafnium, vanadium, niobium and tantalum, and a metallocene component comprising at least one metallocene of at least one of titanium, zirconium, and hafnium.

32. The process of claim 31, wherein the bimetallic catalyst precursor comprises a non-metallocene component comprising at least one of titanium and vanadium, and a metallocene component comprising at least one metallocene of zirconium.

33. The process of claim 27, wherein the olefin monomers comprises at least 80 wt % ethylene.

34. The process of claim 27, wherein the olefin monomers further comprises at least one C₃-C₁₀ alpha-olefin monomer.

35. A process for producing polyethylene copolymers having a target melt flow rate, the process comprising:
(a) combining:
(i) a bimetallic catalyst precursor comprising:
(A) a non-metallocene compound of at least one of titanium and vanadium and
(B) a metallocene compound of zirconium, and
(ii) a cocatalyst comprising:
(A) an organoaluminum compound selected from trimethylaluminum, triethylaluminum, tripropylaluminum, tributylaluminum, triisobutylaluminum, trihexylaluminum and trioctylaluminum and
(B) modified methylaluminoxane, to obtain an activated catalyst;
(b) contacting the activated catalyst with monomers under polymerization conditions to form polyethylene, the monomers comprising 80-99 wt % ethylene and 1-20 wt % of at least one C₃-C₁₀ alpha-olefin;
(c) determining a melt flow rate of the polyolefin; and
(d) increasing the ratio of organoaluminum to modified methylaluminoxane if the melt flow rate is less than the target melt flow rate or decreasing the ratio of organoaluminum to modified methylaluminoxane if the melt flow rate is greater than the target melt flow rate.

36. A process for producing polyolefins comprising a higher molecular weight polymer component and a lower molecular weight polymer component and having target weight fractions of higher and lower molecular weight polymer components, the process comprising:
(a) combining:
(i) a bimetallic catalyst precursor comprising:
(A) a non-metallocene compound of at least one of titanium and vanadium and
(B) a metallocene compound of zirconium, and
(ii) a cocatalyst comprising:
(A) an organoaluminum compound selected from trimethylaluminum, triethylaluminum, tripropylaluminum, tributylaluminum, triisobutylaluminum, trihexylaluminum and trioctylaluminum and
(B) modified methylaluminoxane, to obtain an activated catalyst;
(b) contacting the activated catalyst with monomers under polymerization conditions to form polyethylene, the monomers comprising 80-99 wt % ethylene and 1-20 wt % of at least one C₃-C₁₀ alpha-olefin;
(c) determining the weight fraction of the higher molecular weight polymer component; and
(d) varying the ratio of organoaluminum to modified methylaluminoxane by increasing the ratio of organoaluminum to modified methylaluminoxane if the weight fraction of the higher molecular weight component is greater than a target weight fraction or decreasing the ratio of organoaluminum to modified methylaluminoxane if the weight fraction of the higher molecular weight component is less than the target weight fraction.
